(19) United States
(12) Patent Application Publication
(10) Pub. No.: US 2017/0370318 A1
(43) Pub. Date: Dec. 28, 2017

(54) CONTROL DEVICE FOR DIESEL ENGINE

(71) Applicant: TOYOTA JIDOSHA KABUSHIKI KAISHA, AICHI-KEN (JP)

(72) Inventor: Kouseki SUGIYAMA, Numazu-shi (JP)

(21) Appl. No.: 15/625,124

(22) Filed: Jun. 16, 2017

(30) Foreign Application Priority Data
Jun. 24, 2016 (JP) 2016-125721

(51) Int. Cl. F02D 41/24; F02P 19/02; F02D 41/00; G01L 27/00

(52) U.S. Cl. CPC F02D 41/2474; G01L 27/005; F02P 19/028; F02D 41/009; F02D 2200/024; F02D 2200/101

(57) ABSTRACT

When a diesel engine is determined to be in a motoring state, a hysteresis zero angle H₀ is determined (step S14). Subsequently, a gradient dₙ is calculated (step S16). The gradient dₙ is calculated based on data (θₙ, Δhₙ) of a deviation Δhₙ at a retardation side from the hysteresis zero angle H₀ and at an advance side from a predetermined crank angle. Subsequently, the gradient dₙ and the hysteresis zero angle H₀ are updated (step S18). When the diesel engine is determined to be in a non-motoring state, data (θₙ, Pₙ) of an actual in-cylinder pressure is corrected based on a newest correction coefficient η and hysteresis zero angle H₀ (step S22).

### CROSS-REFERENCE TO RELATED APPLICATION

The present application claims priority under 35 U.S.C. §119 to Japanese Patent Application No. 2016-125721, filed on Jun. 24, 2016. The contents of this application are incorporated herein by reference in their entirety.

### TECHNICAL FIELD

The present application relates to a control device for a diesel engine, and particularly relates to a control device which is configured to control a diesel engine mounted on a vehicle.

### BACKGROUND ART

A diesel engine comprising a glow plug integrated type in-cylinder pressure sensor is known to the public. The glow plug integrated type in-cylinder pressure sensor comprises a pressure receiving section which displaces in an axial direction with an in-cylinder pressure fraction. The pressure receiving section is also configured to work as a heating section of the glow plug.

JP 2010-071197 A discloses a control device which is configured to control a diesel engine equipped with the glow plug integrated type in-cylinder pressure sensor. The control device is configured to calculate a correction coefficient based on a pressure difference between a reference in-cylinder pressure and an actual in-cylinder pressure when the diesel engine is in a motoring state. The control device is further configured to correct an actual in-cylinder pressure when the diesel engine is in a non-motoring state based on the calculated correction coefficient.

When deposits adhere to and accumulate on a periphery of the pressure receiving section, a displacement amount of the pressure receiving section changes, and hysteresis occurs to the actual in-cylinder pressure. In this regard, according to the control device, the correction coefficient can be calculated based on the pressure difference in the motoring state, and therefore, the actual in-cylinder pressure in the non-motoring state can be corrected.

However, according to further verification of the present inventor, it has been found out that there exists a crank angle region where the pressure difference in the non-motoring state becomes difficult to observe in the motoring state. Consequently, in the control device which is configured to correct the correction coefficient by the pressure difference in the motoring state, precision of correction of the actual in-cylinder pressure in the non-motoring state is likely to be reduced.

The present application addresses the above-described problem and has an object to restrain reduction in precision of correction of an actual in-cylinder pressure in a non-motoring state, which is performed based on an actual in-cylinder pressure in a motoring state, in a diesel engine including a glow plug integrated type in-cylinder pressure sensor.

### SUMMARY

A control device for a diesel engine according to one or more embodiments of the present application is a control device which is configured to control a diesel engine including a glow plug integrated type in-cylinder pressure sensor,

wherein the control device is also configured to:

determine a crank angle at which a difference, which is obtained by subtracting a reference in-cylinder pressure at a crank angle at which an actual in-cylinder pressure is detected, from the actual in-cylinder pressure detected by the in-cylinder pressure sensor at each of predetermined crank angles in a cycle in which the diesel engine is in a motoring state, changes from negative to positive;

calculate a rate of change of a pressure difference between the actual in-cylinder pressure and the reference in-cylinder pressure in a predetermined crank angle region at a retardation side from the crank angle at which the difference changes from negative to positive; and

correct the actual in-cylinder pressure detected at each of the predetermined crank angles in the cycle in which the diesel engine is in the non-motoring state, based on a crank angle interval from the crank angle at which the actual in-cylinder pressure is detected to the crank angle at which the difference changes from negative to positive, and the rate of change.

In the control device according to one or more embodiments of the present application, the crank angle at which the difference changes from negative to positive may be a crank angle at a retardation side from a compression top dead center.

The control device may also be configured to correct the rate of change by relating the rate of change to an amount of fuel that is injected into a cylinder of the diesel engine. The rate of change may be corrected to a smaller value as the amount of fuel is larger.

The control device may also be configured to correct the rate of change by relating the rate of change to an engine speed in the motoring state.

The control device may also be configured to before calculating the difference:

correct data of the actual in-cylinder pressure so that a maximum value of the actual in-cylinder pressure detected by the in-cylinder pressure sensor at each of the predetermined crank angles in the cycle in which the diesel engine is in the motoring state becomes equal to a maximum value of the reference in-cylinder pressure; and

correct the data of the actual in-cylinder pressure so that a crank angle showing the maximum value corresponds to a top dead center.

The control device may also be configured to correct the actual in-cylinder pressure detected at each of the predetermined crank angles in the cycle in which the diesel engine is in the non-motoring state, based on equation (1) as follows:

Correction value of actual in-cylinder pressure-value Pₙ of actual in-cylinder pressure×(detection crank angle θₙ−hysteresis zero angle H₀)×correction coefficient η (1),

in equation (1), the value Pₙ of the actual in-cylinder pressure means the actual in-cylinder pressure detected at each of the predetermined crank angles in the cycle in which the diesel engine is in the non-motoring state, the detection crank angle θₙ means the crank angle at which the value Pₙ of the actual in-cylinder pressure is detected, the hysteresis zero angle H₀ means the crank angle at which the difference changes from negative to positive, and the correction coefficient η means the rate of change.

The control device may also be configured to correct the actual in-cylinder pressure detected at each of the predetermined crank angles in the cycle in which the diesel engine is in the non-motoring state, based on equation (2) as follows:

Correction value Pₙ of actual in-cylinder pressure=value Pₙ of actual in-cylinder pressure×(detection crank angle θₙ−hysteresis zero angle H₀)×correction coefficient η/100 (2),

in equation (2), the value Pₙ of the actual in-cylinder pressure means the actual in-cylinder pressure detected at each of the predetermined crank angles in the cycle in which the diesel engine is in the non-motoring state, the detection crank angle θₙ means the crank angle at which the value Pₙ of the actual in-cylinder pressure is detected, the hysteresis zero angle H₀ means the crank angle at which the difference changes from negative to positive, and the correction coefficient η means a percentage of a value obtained by dividing the rate of change by the reference in-cylinder pressure.

In the motoring state, there exists the crank angle at which a magnitude relation of the actual in-cylinder pressure detected by the in-cylinder pressure sensor, and the reference in-cylinder pressure in the crank angle at which the actual in-cylinder pressure is detected is reversed. In a crank angle region at an advance side from the crank angle at which the magnitude relation is reversed, the pressure difference between the actual in-cylinder pressure and the reference in-cylinder pressure is difficult to observe.

According to one or more embodiments of the present application, the crank angle at which the magnitude relation of the actual in-cylinder pressure and the reference in-cylinder pressure is reversed can be determined. Further, the rate of change of the pressure difference can be calculated based on the data of the pressure difference in the predetermined crank angle region at the retardation side from the determined crank angle. In other words, at the time of calculation of the rate of change of the pressure difference, the data of the pressure difference in the crank angle region at the advance side from the determined crank angle can be excluded. Consequently, the rate of change of the pressure difference can be calculated more accurately. Accordingly, precision of correction of the actual in-cylinder pressure in the non-motoring state can be enhanced.

In the motoring state, the pressure difference between the actual in-cylinder pressure and the reference in-cylinder pressure is observed stably in the crank angle region at the retardation side from the compression top dead center.

According to one or more embodiments of the present application, the crank angle at which the above described magnitude relation is reversed can be determined as the crank angle at the retardation side from the compression top dead center. Accordingly, precision of correction of the actual in-cylinder pressure in the non-motoring state can be enhanced.

When the amount of the fuel which is injected into the cylinder increases, the maximum value of the in-cylinder temperature at the time of combustion increases. When the maximum value of the in-cylinder temperature increases, viscosity of deposits that adhere to and accumulate on a periphery of a pressure receiving section of the in-cylinder pressure sensor reduces. When the viscosity of the deposits reduces, the pressure receiving section of the in-cylinder pressure sensor easily moves, so that the hysteresis which occurs to the actual in-cylinder pressure reduces.

According to one or more embodiments of the present application, the rate of change of the pressure difference can be corrected to a smaller value as the fuel injection amount in the non-motoring state is larger. Accordingly, precision of correction of the actual in-cylinder pressure in the non-motoring state can be further enhanced.

The engine speed in the motoring state may have an influence on the relation between the rate of change of the pressure difference and the fuel injection amount.

According to one or more embodiments of the present application, the rate of change of the pressure difference can be corrected by being related to the engine speed in the motoring state. Consequently, the influence which the engine speed in the motoring state gives can be reduced.

According to one or more embodiments of the present application, the difference can be accurately calculated, which is obtained by subtracting the reference in-cylinder pressure at the crank angle at which the actual in-cylinder pressure is detected, from the actual in-cylinder pressure detected by the in-cylinder pressure sensor at each of the predetermined crank angles in the cycle in which the diesel engine is in the motoring state.

According to one or more embodiments of the present application, the actual in-cylinder pressure in the non-motoring state can be corrected based on equation (1) described above.

According to one or more embodiments of the present application, the actual in-cylinder pressure in the non-motoring state can be corrected based on equation (2) described above.

### BRIEF DESCRIPTION OF DRAWINGS

FIG. 1 is a schematic diagram explaining a configuration of a diesel engine to which a control device according to a first embodiment of the present application is applied;

FIG. 2 is a functional block diagram of an ECU 20 as the control device according to the first embodiment of the present application;

FIG. 3 is a diagram explaining a problem in an in-cylinder pressure sensor 10;

FIG. 4 is a diagram explaining a problem in the in-cylinder pressure sensor 10;

FIG. 5 is a diagram illustrating processing images of data of actual in-cylinder pressures in a Pₘₐₓ correction section 46a and a TDC correction section 46b illustrated in FIG. 2;

FIG. 6 is a diagram explaining hysteresis between a correction value Pₙ′ of an actual in-cylinder pressure in a motoring state, and a value PRₙ of a reference in-cylinder pressure;

FIG. 7 is a diagram explaining details of the hysteresis between “reference values” and “sensor values” observed in FIG. 4 and FIG. 6;

FIG. 8 is a diagram explaining details of the hysteresis between the “reference values” and the “sensor values” observed in FIG. 4 and FIG. 6;

FIG. 9 is a diagram illustrating a processing image of a deviation Δhₙ in a hysteresis zero angle determination section 46c and a gradient calculation section 46d illustrated in FIG. 2:

FIG. 10 is a diagram illustrating a processing image of data of an actual in-cylinder pressure in an in-cylinder pressure correction section 44 illustrated in FIG. 2;

FIG. 11 is a flowchart illustrating one example of data processing of an actual in-cylinder pressure realized by a function of the ECU 20;

FIG. 12 is a functional block diagram of the ECU 20 as a control device according to a second embodiment of the present application:

FIG. 13 is a diagram explaining a method for relating a gradient dₙ to a fuel injection amount; and

FIG. 14 is one example of a diagram illustrating the relationship illustrated in FIG. 13 at each engine speed in the motoring state.

### DESCRIPTION OF EMBODIMENTS

Hereunder, one or more embodiments of the present application will be described based on the drawings. Note that common elements in the respective drawings are assigned with the same reference signs, and redundant explanation will be omitted. Further, the present application is not limited by the one or more embodiments as follows.

### First Embodiment

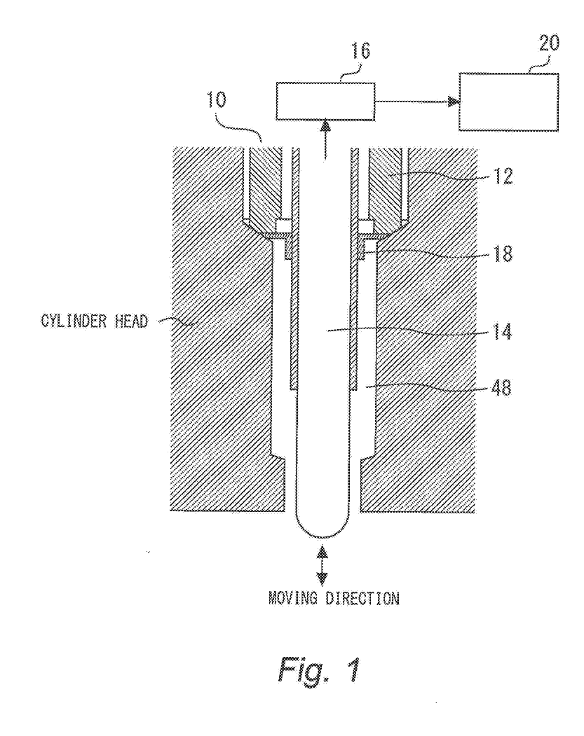

First of all, a first embodiment of the present application will be described with reference to FIG. 1 to FIG. 11.

FIG. 1 is a schematic diagram explaining a configuration of a diesel engine to which a control device according to the first embodiment of the present application is applied. The diesel engine to which the control device according to the present embodiment is applied includes a glow plug integrated type in-cylinder pressure sensor 10. The in-cylinder pressure sensor 10 includes a hollow housing 12. In a shaft hole of the housing 12, a pressure receiving section 14 that also functions as a heater rod is inserted. The pressure receiving section 14 is configured to be movable in an axial direction thereof. When a pressure in a cylinder changes, a magnitude of a load that is transmitted to a sensing section 16 via the pressure receiving section 14 changes. The change of the load is detected by the sensing section 16, and thereby the pressure in the cylinder is detected. A seal member 18 is provided between the housing 12 and the pressure receiving section 14. The seal member 18 is provided, and thereby leakage of gas in the cylinder to an outside is prevented.

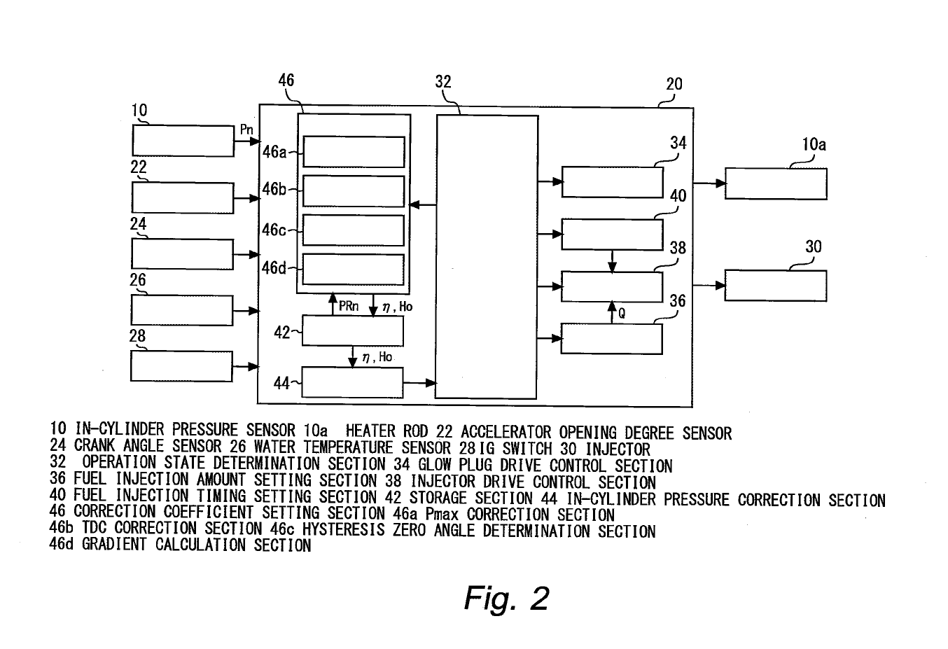

The control device according to the present embodiment is realized as a part of a function of the ECU 20 that controls the diesel engine. The ECU 20 takes in and processes signals of various sensors installed in the diesel engine. FIG. 2 illustrates various sensors that are connected to the ECU 20. As illustrated in FIG. 2, the various sensors include at least an accelerator opening degree sensor 22, a crank angle sensor 24, a water temperature sensor 26 and an ignition switch 28, besides the in-cylinder pressure sensor 10 illustrated in FIG. 1.

The accelerator opening degree sensor 22 detects a depressing amount on an accelerator pedal. The crank angle sensor 24 detects a rotation angle of a crankshaft. The water temperature sensor 26 detects a cooling water temperature of the diesel engine. The ignition switch 28 receives an instruction to supply/stop electric power to an electric power system of the diesel engine.

The ECU 20 processes the signals taken in from the aforementioned various sensors, and operates various actuators of a system in accordance with a predetermined control program. FIG. 2 also illustrates various actuators that are connected to the ECU 20. As illustrated in FIG. 2, the various actuators include at least an injector 30 that injects fuel into the cylinder of the diesel engine, besides a heater rod 10a of the in-cylinder pressure sensor 10.

FIG. 2 illustrates functional blocks of the ECU 20 as the control device according to the present embodiment. As illustrated in FIG. 2, the ECU 20 includes an operation state determination section 32, a glow plug drive control section 34, a fuel injection amount setting section 36, a fuel injection timing setting section 40 and an injector drive control section 38.

The operation state determination section 32 determines an operation state of the diesel engine. The glow plug drive control section 34 performs energization (glow energization) to the heater rod 10a while a cooling water temperature that is detected by the water temperature sensor 26 is lower than a predetermined temperature at a time of a cold start of the diesel engine. The energization is started by an ON signal from the ignition switch 28. Further, the energization is ended at a time point at which the cooling water temperature rises to a temperature higher than a predetermined temperature. The fuel injection amount setting section 36 sets a fuel injection amount corresponding to a depressing amount on the accelerator pedal based on the operation state determined by the operation state determination section 32. The fuel injection amount setting section 36 also outputs the set fuel injection amount to the injector drive control section 38. The fuel injection timing setting section 40 sets an injection mode, an injection timing and the like that correspond to the fuel injection amount which is set by the fuel injection amount setting section 36. The fuel injection timing setting section 40 also outputs the injection mode, the injection timing and the like which are set, to the injector drive control section 38.

The ECU 20 also includes a storage section 42, an in-cylinder pressure correction section 44, and a correction coefficient setting section 46, as components for performing correction of the in-cylinder pressure detected by the in-cylinder pressure sensor 10.

The storage section 42 stores a correction coefficient η for correcting a value Pₙ of the actual in-cylinder pressure, and a value PRₙ of a reference in-cylinder pressure. The value Pₙ of the actual in-cylinder pressure is a value of an in-cylinder pressure which is detected at each predetermined crank angle θ₁ by the in-cylinder pressure sensor 10. The value PRₙ of the reference in-cylinder pressure is a value (an initial value) of an in-cylinder pressure at a time of the sensor being brand new, and in a motoring state. As the initial value, a value of an in-cylinder pressure that is obtained in advance by an in-cylinder pressure sensor having a configuration equivalent to the configuration of the in-cylinder pressure sensor 10 is usually used.

Here, the motoring state refers to an operation state in which the engine speed of the diesel engine is in a low speed region, the depressing amount on the accelerator pedal is zero and fuel is not injected from the injector 30. A region of 3000 rpm or less is cited as an example of the low speed region, but it is needless to say that the low speed region should be properly changed in accordance with an engine system. The correction coefficient η is updated each time the correction coefficient η is set in the correction coefficient setting section 46. Note that details of the correction coefficient η will be described later. Further, the storage section 42 is assumed to store data necessary to realize the function in the present embodiment in addition to the correction coefficient η.

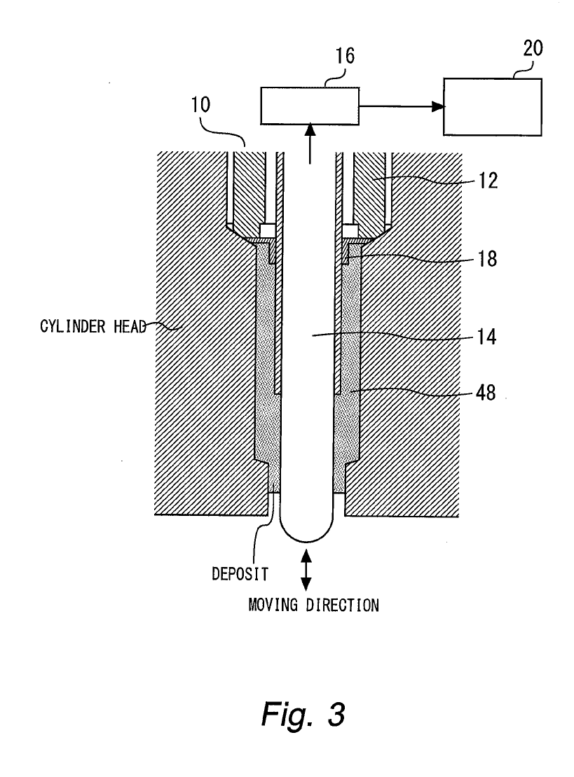

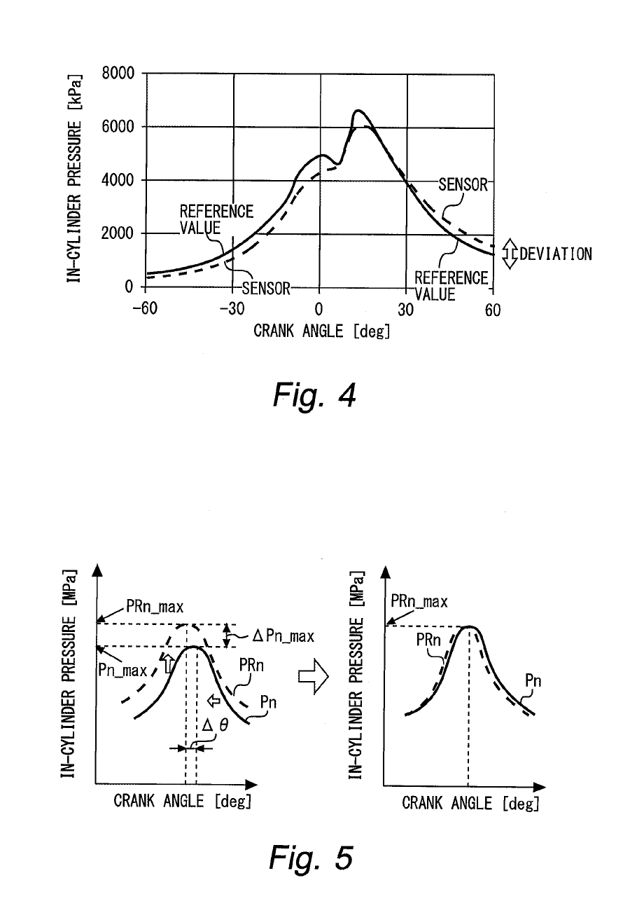

Before explaining the in-cylinder pressure correction section 44 and the correction coefficient setting section 46, a problem in the in-cylinder pressure sensor 10 will be described with reference to FIGS. 3 and 4. As illustrated in FIG. 3, a small gap exists between a sensor insertion hole 48 that is formed in the cylinder head, and the pressure receiving section 14. When soot that is generated in the cylinder, unburned fuel, engine oil and the like enter the gap, and adhere to a wall surface of the sensor insertion hole 48 and a surface of the pressure receiving section 14, the soot, unburned fuel, engine oil and the like may become deposits. When soot and the like further adhere to the deposits, or the deposits bond to deposits around them, the deposits accumulate. When deposits adhere to or accumulate on the surface of the pressure receiving section 14, a movement characteristic in an axial direction of the pressure receiving section 14 changes.

When the movement characteristic in the axial direction of the pressure receiving section 14 changes, hysteresis occurs to the value Pₙ of the actual in-cylinder pressure. FIG. 4 is a diagram explaining the hysteresis. FIG. 4 is created when fuel is injected from the injector 30, that is, when the diesel engine is in a non-motoring state. In FIG. 4, the value Pₙ of the actual in-cylinder pressure at a time of deposit adherence/accumulation is expressed by a “sensor value”, and the value Pₙ of the actual in-cylinder pressure at a time of a sensor being brand new is expressed by a “reference value”. As is understandable when tendencies of the “sensor value” and the “reference value” illustrated in FIG. 4 are compared, hysteresis is observed between both of them. Describing in more detail, from 60° before a compression top dead center to a vicinity of 10° after the compression top dead center, the “reference value” is substantially larger than the “sensor value”. Contrary to the above, at a retardation side from the vicinity of 10° after the compression top dead center, the “reference value” is substantially smaller than the “sensor value”.

Returning to FIG. 2, explanation of the functions of the ECU 20 will be continued. The correction coefficient setting section 46 sets the correction coefficient η by using data of the reference in-cylinder pressure received from the storage section 42, and data of the actual in-cylinder pressure in the motoring state. As components for setting the correction coefficient η, the correction coefficient setting section 46 includes a Pₘₐₓ correction section 46a, a TDC correction section 46b, a hysteresis zero angle determination section 46c and a gradient calculation section 46d.

First, the Pₘₐₓ correction section 46a and the TDC correction section 46b will be described. In the Pₘₐₓ correction section 46a and the TDC correction section 46b, preprocessing of the data of the actual in-cylinder pressure in the motoring state is performed. As already described, the actual in-cylinder pressure is detected at each of predetermined crank angles θ₁ (intervals of 10° as an example). Consequently, when the values Pₙ of the actual in-cylinder pressure from 60° before the compression top dead center to 60° after the compression top dead center are arranged in sequence of the detection crank angles, data (θₙ, Pₙ) is expressed by (θ_{BTDC60°}, P_{BTDC60°}), (θ_{BTDC60°+θ1}, P_{BTDC60°+θ1}), . . . , (θ_{ATDC60°-θ1}, P_{ATDC60°-θ1}), and (θ_{ATDC60°}, P_{ATDC60°}).

The Pₘₐₓ correction section 46a corrects the data (θₙ, Pₙ) so that a maximum value Pₙ_{_}ₘₐₓ of the actual in-cylinder pressure in the motoring state becomes equal to a maximum value PRₙ_{_{—max}} of the reference in-cylinder pressure. More specifically, the Pₘₐₓ correction section 46a firstly detects a pressure difference ΔPₙ_{_}ₘₐₓ between the maximum value Pₙ_{_{—max}} and the maximum value PRₙ_{_}ₘₐₓ. When the pressure difference ΔPₙ_{_}ₘₐₓ is detected, the Pₘₐₓ correction section 46a corrects the value Pₙ of the actual in-cylinder pressure to increase the value Pₙ by the pressure difference ΔPₙ_{_}ₘₐₓ, or decrease the value Pₙ by ΔPₙ_{_}ₘₐₓ.

The TDC correction section 46b corrects the data (θₙ, Pₙ) so that a crank angle showing the maximum value Pₙ_{_}ₘₐₓ of the actual in-cylinder pressure in the motoring state corresponds to a TDC. More specifically, the TDC correction section 46b firstly detects a phase difference Δθ of the crank angle showing the maximum value Pₙ_{_}ₘₐₓ and the TDC. When the phase difference Δθ is detected, the TDC correction section 46b corrects the value of a detection crank angle θₙ to a retardation side or an advance side by the phase difference Δθ.

FIG. 5 illustrates a processing image of the data (θₙ, Pₙ) in the Pₘₐₓ correction section 46a and the TDC correction section 46b. In FIG. 5, the maximum value PRₙ_{_}ₘₐₓ is larger than the maximum value Pₙ_{_}ₘₐₓ. Consequently, in the Pₘₐₓ correction section 46a, the value Pₙ of the actual in-cylinder pressure is corrected to increase by an amount of the pressure difference ΔPₙ_{_}ₘₐₓ. Further, in FIG. 5, the crank angle showing the maximum value Pₙ_{_}ₘₐₓ is located at a retardation side from the TDC. Consequently, in the TDC correction section 46b, the value of the detection crank angle θₙ is corrected to the advance side by the amount of the phase difference Δθ.

Next, the hysteresis zero angle determination section 46c and the gradient calculation section 46d will be described. The hysteresis zero angle determination section 46c calculates a deviation Δhₕ of a correction value Pₙ′ of the actual in-cylinder pressure to the value of the reference in-cylinder pressure PRₙ based on correction data (θₙ′, Pₙ′) of the actual in-cylinder pressure, and data (θₙ, PRₙ) of the values of the reference in-cylinder pressure PRₙ arranged in sequence of the detection crank angles. The hysteresis zero angle determination section 46c determines a crank angle (hereinafter, also referred to as “a hysteresis zero angle H₀”) at which a value of the deviation Δhₙ changes from negative to positive. The gradient calculation section 46d calculates a gradient dₙ of the deviation Δhₙ in a crank angle region at a retardation side from the hysteresis zero angle H₀.

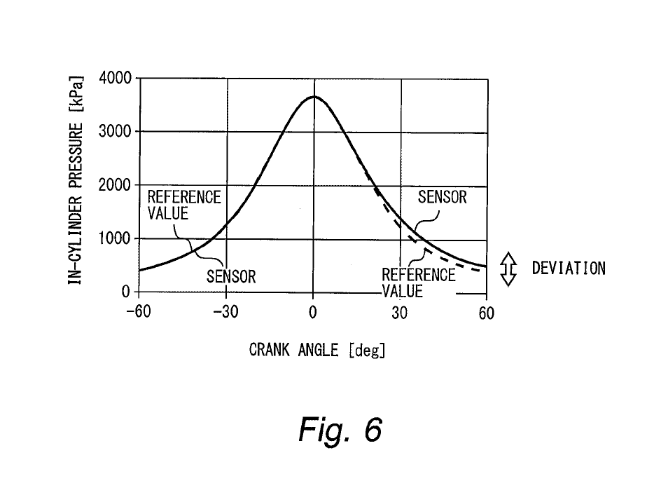

FIG. 6 is a diagram explaining hysteresis between the correction value Pₙ′ of the actual in-cylinder pressure in the motoring state, and the PRₙ of the reference in-cylinder pressure. In FIG. 6, the correction value Pₙ′ of the actual in-cylinder pressure at a time of deposit adherence/accumulation is expressed by a “sensor value” and the value Pₙ of the actual in-cylinder pressure at the time of the sensor being brand new is expressed by a “reference value”. As is understandable when tendencies of the “sensor value” and the “reference value” illustrated in FIG. 6 are compared, hysteresis is observed between both of them. Describing in more detail, the “reference value” becomes lower than the “sensor value” in a retardation side from a vicinity of 10° after the compression top dead center. However, as is understandable when FIG. 6 is compared with FIG. 4, FIG. 6 illustrating the tendency in the motoring state, and FIG. 4 illustrating the tendency in the non-motoring state differ in the crank angle region where hysteresis is observed.

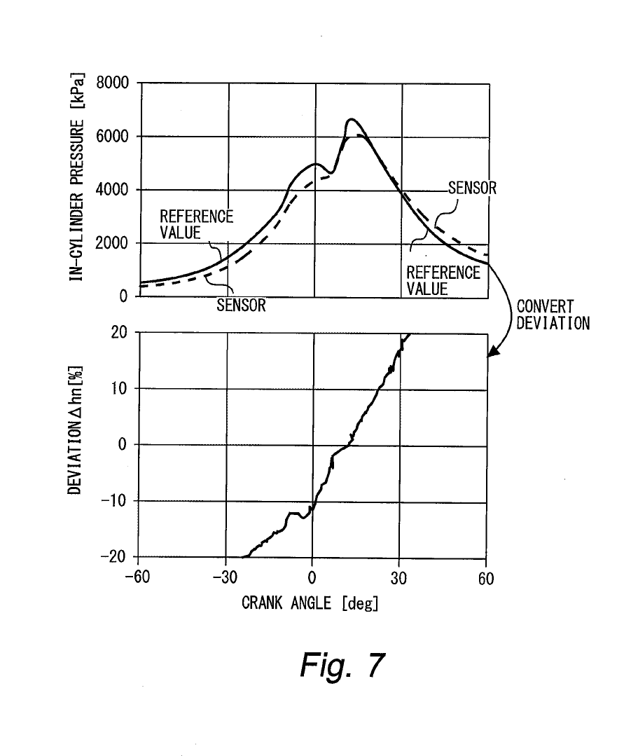

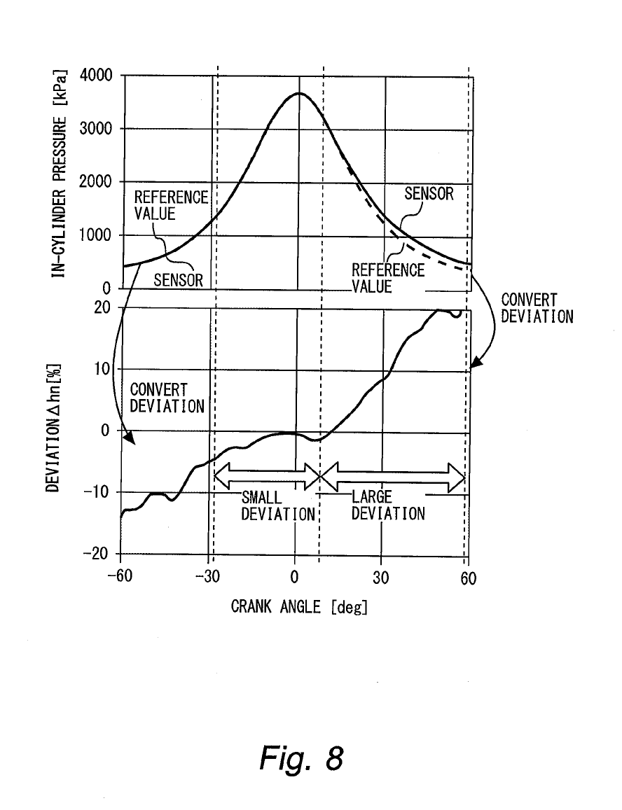

FIGS. 7 and 8 are diagrams explaining details of the hysteresis of the “reference values” and the “sensor values” observed in FIGS. 4 and 6. The same diagram as in FIG. 4 is illustrated on an upper tier of FIG. 7, and the deviation Δhₙ of the “sensor value” to the “reference value” illustrated in FIG. 4 is illustrated in a lower tier in FIG. 7. Further, the same diagram as in FIG. 6 is drawn on an upper tier in FIG. 8, and the deviation Δhₙ of the “sensor value” to the “reference value” illustrated in FIG. 6 is illustrated in a lower tier in FIG. 8. The deviation Δhₙ of the “sensor value” to the “reference value” is expressed as a percentage calculated by substituting the “reference value” and the “sensor value” at the same crank angle into equation (1) as follows.

Deviation Δhₙ [%]=100×(sensor value−reference value)/reference value (1)

In the lower tier in FIG. 7, a gradient (that is, a rate of change of the deviation Δhₙ) of the deviation Δhₙ is substantially constant. In the lower tier in FIG. 8, a gradient of the deviation Δhₙ becomes small in a crank region at an advance side from the vicinity of 10° after the compression top dead center. In particular, in the crank angle region from the a vicinity of 30° before the compression top dead center to the vicinity of 10° after the compression top dead center, the gradient of the deviation Δhₙ becomes remarkably small. The cause of occurrence of such a difference is not certain. However, the present inventor surmises that the difference between the maximum value Pₙ_{_}ₘₐₓ and the minimum value Pₙ_{_}ₘᵢₙ of the actual in-cylinder pressure is originally small because combustion is not performed in the motoring state, and therefore hysteresis is difficult to observe in the crank angle region at the advance side from the compression top dead center.

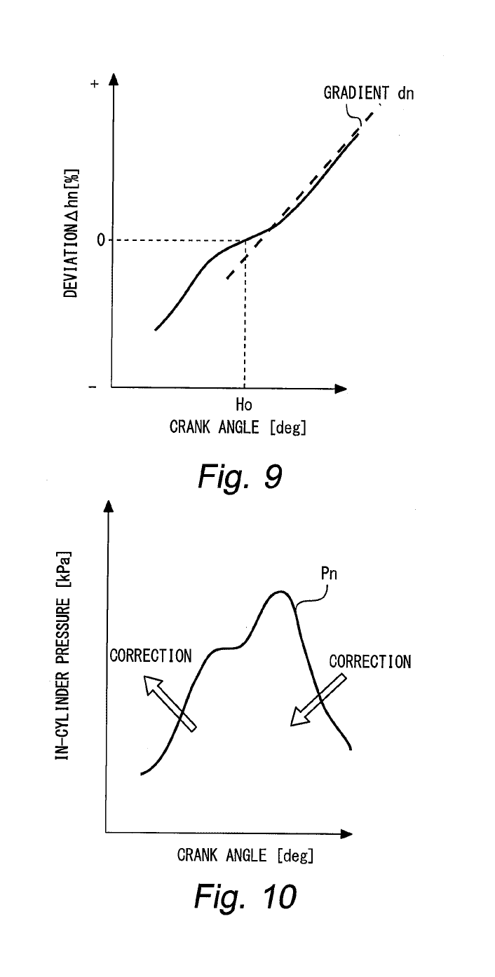

The hysteresis zero angle determination section 46c and the gradient calculation section 46d perform processing in which characteristics peculiar to the motoring state like this are taken into consideration. FIG. 9 is a diagram illustrating a processing image of the deviation Δhₙ in the hysteresis zero angle determination section 46c and the gradient calculation section 46d. FIG. 9 illustrates the deviation Δhₙ illustrated in the lower tier in FIG. 8, which is in the vicinity of 10° after the compression top dead center. The hysteresis zero angle H₀ is determined as a crank angle at a time of the value of the deviation Δhₙ illustrated by the solid line corresponds to zero. Further, from the value of the deviation Δhₙ in the crank angle region at the retardation side from the hysteresis zero angle H₀, a gradient dₙ illustrated by a broken line is calculated.

In calculation of the gradient dₙ, data (θₙ, Δhₙ) of the deviation Δhₙ at the retardation side from the hysteresis zero angle H₀, and at an advance side from a predetermined crank angle (60° after the compression top dead center, as an example) is used. In other words, data (θₙ, Δhₙ) of the deviation Δhₙ at an advance side from the hysteresis zero angle H₀, and data (θₙ, Δhₙ) at a retardation side from the predetermined crank angle are not used in calculation of the gradient dₙ.

Calculation of the gradient dₙ is performed by using data (θₙ, Δhₙ) of at least two deviations Δhₙ.

For example, when arbitrary two data (θ_{k+θ1}, Δh_{k+θ1}) and (θ_{k-θ1}, Δh_{k-θ1}) of the data (θₙ, Δhₙ) of the deviation Δhₙ in the aforementioned crank angle region are used, the gradient dₙ can be obtained by equation (4) as follows.

Gradient dₙ=gradient dₖ=(Δhₖ₊₁−Δhₖ₋₁)/(θₖ₊₁−θₖ₋₁) (4)

Further, for example, when all the data (θₙ, Δhₙ) of the deviation Δhₙ in the aforementioned crank angle region are used, the gradient dₙ can be obtained by equation (5) as follows.

Gradient dₙ=average of gradient dₖ=ave{(Δh_{n+θ1}−Δh_{n-θ1})/(θ_{n+θ1}−θ_{n-θ1})} (5)

Further, for example, a plurality of gradients dₖ obtained by equation (4) described above are obtained within the aforementioned crank angle region, and a maximum value of the plurality of gradients dₖ can be used as the gradient dₙ (refer to equation (6) as follows).

Gradient dₙ=maximum value of gradient dₖ=max{(Δh_{n+θ1}−Δh_{n-θ1})/(θ_{n+θ1}−θ_{n-θ1})} (6)

The correction coefficient setting section 46 outputs the value of the hysteresis zero angle H₀ to the storage section 42. In addition, the correction coefficient setting section 46 outputs the value of the gradient dₙ to the storage section 42 as the correction coefficient η.

The in-cylinder pressure correction section 44 receives the correction coefficient η and the date of the hysteresis zero angle H₀ from the storage section 42, and performs correction of the value Pₙ of the actual in-cylinder pressure in the non-motoring state. The value Pₙ of the actual in-cylinder pressure that configures the data (θₙ, Pₙ) of the actual in-cylinder pressure in the non-motoring state is corrected by equation (7) as follows that uses a crank angle interval from the hysteresis zero angle H₀ to the detection crank angle θₙ for example, and the correction coefficient η.

Correction value Pₙ of actual in-cylinder pressure=value Pₙ of actual in-cylinder pressure×(detection crank angle θₙ−hysteresis zero angle H₀)×correction coefficient η/100 (7)

FIG. 10 is a diagram illustrating a processing image of data of the actual in-cylinder pressure in the in-cylinder pressure correction section 44. As illustrated in FIG. 10, in the in-cylinder pressure correction section 44, the value Pₙ of the actual in-cylinder pressure is corrected to an increase side, in the crank angle region at the advance side from the compression top dead center, when classifying roughly. Contrary to the above, in the crank angle region at the retardation side from the compression top dead center, the value Pₙ of the actual in-cylinder pressure is corrected to a decrease side. That is, the data of the actual in-cylinder pressure is corrected in a direction to eliminate the hysteresis of the “sensor value” and the “reference value” explained with FIG. 4.

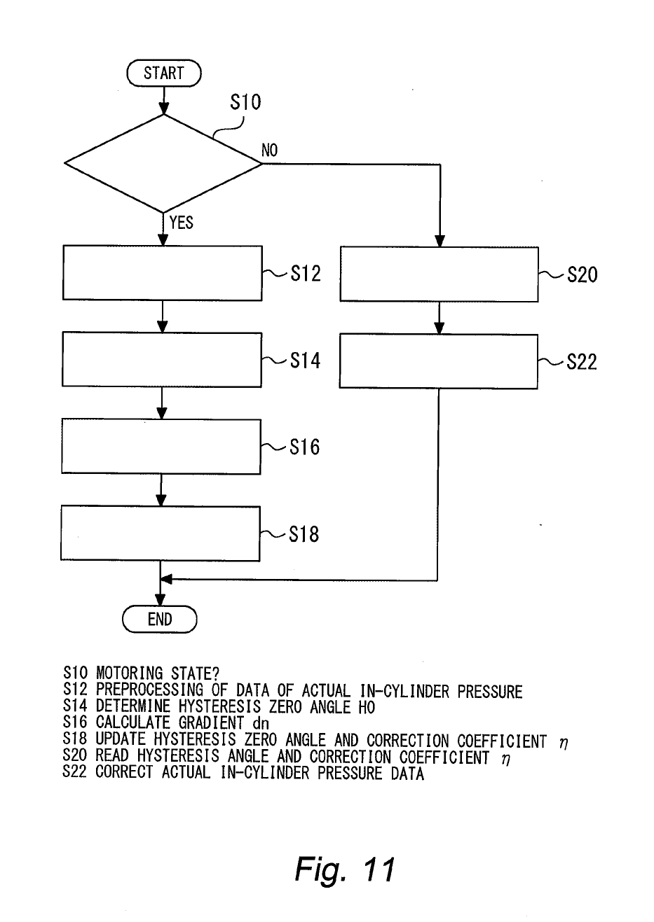

FIG. 11 is a flowchart illustrating an example of data processing of the actual in-cylinder pressure which is realized by the function of the ECU 20 described above. Note that the routine illustrated in FIG. 11 is repeatedly executed at each cycle after start of the diesel engine.

In the routine illustrated in FIG. 11, it is firstly determined whether the diesel engine is in a motoring state (step S10). In the present step, processing as follows is performed. First, an engine speed is calculated based on a detection value of the crank angle sensor 24. Further, a detection value of the accelerator opening degree sensor 22 is acquired. When the engine speed is less than a threshold value, and the detection value of the accelerator opening degree sensor 22 is equal to zero, it is determined that the diesel engine is in the motoring state. When the engine speed is the threshold value or more, or the detection value of the accelerator opening degree sensor 22 is not zero, it is determined that the diesel engine is in the non-motoring state.

When it is determined that the diesel engine is in the motoring state in step S10, the preprocessing of the data (θₙ, Pₙ) of the actual in-cylinder pressure is performed (step S12). In the present step, processing as follows is performed. First, the value PRₙ of the reference in-cylinder pressure is read from the storage section 42. Subsequently, the data (θₙ, Pₙ) is corrected so that the maximum value PRₙ_{_}ₘₐₓ of the reference in-cylinder pressure and the maximum value Pₙ_{_}ₘₐₓ of the actual in-cylinder pressure correspond to each other (refer to the Pₘₐₓ correction section 46a in FIG. 2). Subsequently, the data (θₙ, Pₙ) is further corrected so that the crank angle showing the maximum value Pₙ_{_}ₘₐₓ of the actual in-cylinder pressure corresponds to the TDC (refer to the TDC correction section 46b in FIG. 2).

Subsequently to step S12, the hysteresis zero angle H₀ is determined (step S14). In the present step, processing as follows is performed. First, the deviation Δhₙ is calculated based on the correction data (θₙ′, Pₙ′) and the data of the reference in-cylinder pressure (θₙ, PRₙ). In calculation of the deviation Δhₙ, equation (1) described above is used. Subsequently, the crank angle at a time of the value of the deviation Δhₙ changing from negative to positive is determined as the hysteresis zero angle H₀ (the hysteresis zero angle determination section 46c in FIG. 2). Note that as explained with FIG. 6, the value of the deviation Δhₙ changes from negative to positive at the retardation side from the compression top dead center. Consequently, determination of the crank angle described above may be performed after the crank angle region is narrowed down to the crank angle region at the retardation side from the compression top dead center.

Subsequently to step S14, the gradient dₙ is calculated (step S16). In the present step, the gradient dₙ is calculated based on the data (θₙ, Δhₙ) of the deviation Δhₙ at the retardation side from the hysteresis zero angle H₀ and at the advance side from the predetermined crank angle (refer to the gradient calculation section 46d in FIG. 2). Any one of equations (4) to (6) described above is used in calculation of the gradient dₙ.

Subsequently to step S16, the correction coefficient η and the hysteresis zero angle H₀ are updated (step S18). In the present step, the gradient dₙ calculated in step S16 is stored in the storage section 42 as the newest correction coefficient η. Further, the hysteresis zero angle H₀ determined in step S14 is stored in the storage section 42 as the newest hysteresis zero angle H₀.

When it is determined that the diesel engine is in the non-motoring state in step S10, the newest correction coefficient η and the hysteresis zero angle H₀ are read from the storage section 42 (step S20).

Subsequently to step S20, the data (θₙ, Pₙ) of the actual in-cylinder pressure is corrected (step S22). In the present step, the data (θₙ, Pₙ) of the actual in-cylinder pressure, the newest correction coefficient η and hysteresis zero angle H₀ are substituted into equation (7) as described above.

As above, according to the routine illustrated in FIG. 11, determination of the hysteresis zero angle H₀ and calculation of the gradient dₙ can be performed from the data (θₙ, Pₙ) of the actual in-cylinder pressure in the motoring state. Further, the data (θₙ, Pₙ) of the actual in-cylinder pressure can be corrected by using the determined hysteresis zero angle H₀ and the calculated gradient dₙ (that is, the correction coefficient η) in the non-motoring state. The hysteresis zero angle H₀ and the correction coefficient η that are used in the non-motoring state are determined or calculated in a latest motoring state. Accordingly, precision of correction of the data of the actual in-cylinder pressure in the non-motoring state can be enhanced, and precision of combustion control of the diesel engine using the data can be enhanced.

Incidentally, in the above described first embodiment, the value of the deviation Δhₙ changes from negative to positive at the retardation side from the compression top dead center, and therefore, the crank angle at which the reversal occurs is determined as the hysteresis zero angle H₀. However, since the cause of occurrence of difference in the gradient of the deviation Δhₙ is not certain as described in explanation of comparison of the lower tier in FIG. 7 and the lower tier in FIG. 8, there is a possibility that the crank angle at which the reversal of positive and negative of the value of the deviation Δhₙ occurs corresponds to the compression top dead center, or is at the advance side from the compression top dead center. However, it is needless to say that even in the case like this, if the crank angle at which the reversal of positive and negative of the value of the deviation Δhₙ occurs is determined as the hysteresis zero angle H₀, the gradient dₙ can be calculated as in the above described first embodiment. Note that the present modification example can be similarly applied to a second embodiment that will be described later.

Further, in the above described first embodiment, the hysteresis zero angle H₀ and the gradient dₙ are calculated by using the value of the deviation Δhₙ calculated in accordance with equation (1) described above. However, the hysteresis zero angle H₀ and the gradient dₙ (that is, the rate of change of the pressure difference ΔPₙ) may be calculated by using the value of the pressure difference ΔPₙ that is calculated by equation (8) as follows that is obtained by simplifying equation (1) described above.

Pressure difference ΔPₙ=value Pₙ of actual in-cylinder pressure-value PRₙ of reference in-cylinder pressure (8)

In this connection, when the hysteresis zero angle H₀ which is determined from equation (8) described above is used, the value Pₙ of the actual in-cylinder pressure configuring the data (θₙ, Pₙ) of the actual in-cylinder pressure in the non-motoring state is corrected by equation (9) as follows.

Correction value of actual in-cylinder pressure=value Pₙ of actual in-cylinder pressure×(detection crank angle θₙ−hysteresis zero angle H₀)×correction coefficient η (9)

Note that the present modification example can be similarly applied to the second embodiment which will be described later.

### Second Embodiment

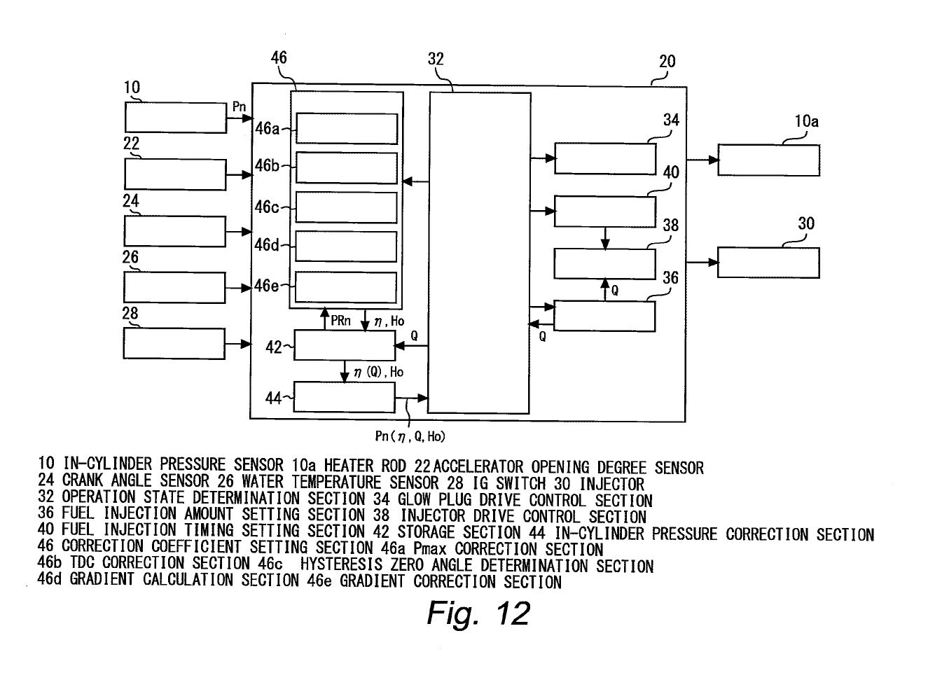

Next, the second embodiment of the present application will be described with reference to FIGS. 12 to 14.

Note that a configuration of a diesel engine to which a control device according to the present embodiment is applied, and basic functions of the ECU 20 are common to the above described first embodiment, and therefore, explanation thereof will be omitted or simplified.

FIG. 12 is a functional block diagram of the ECU 20 as the control device according to the second embodiment of the present application. The basic functions of the ECU 20 are the same as the functions explained in FIG. 2. However, in FIG. 12, a gradient correction section 46e is provided. Further, in FIG. 12, the value Q of the fuel injection amount is outputted to not only the injector drive control section 38 but also the operation state determination section 32. In FIG. 12, the value Q of the fuel injection amount outputted to the operation state determination section 32 is also outputted to the storage section 42.

In the above described first embodiment, the gradient dₙ calculated in the motoring state is set as the correction coefficient η, and the correction coefficient η is used in correction of the data (θₙ, Pₙ) of the actual in-cylinder pressure in the non-motoring state. However, in the motoring state, the value Q of the fuel injection amount is zero, whereas in the cycle in the non-motoring state, the value Q of the fuel injection amount becomes larger than zero. Here, combustion is performed when the value Q of the fuel injection amount is larger than zero, and as the value Q of the fuel injection amount increases, a maximum value of the in-cylinder temperature at the time of combustion increases. When the maximum value of the in-cylinder temperature increases, viscosity of the deposits adhering to and accumulating on the periphery of the pressure receiving section of the in-cylinder pressure sensor 10 decreases. When the viscosity of the deposits decreases, the pressure receiving section 14 easily moves, and therefore the hysteresis that occurs to the value Pₙ of the actual in-cylinder pressure reduces. That is, the difference between the “sensor value” and the “reference value” explained in FIG. 14 decreases. Therefore, the deviation Δhₙ that is calculated in equation (1) described above, and the gradient dₙ that is calculated in equations (4) to (6) described above decrease.

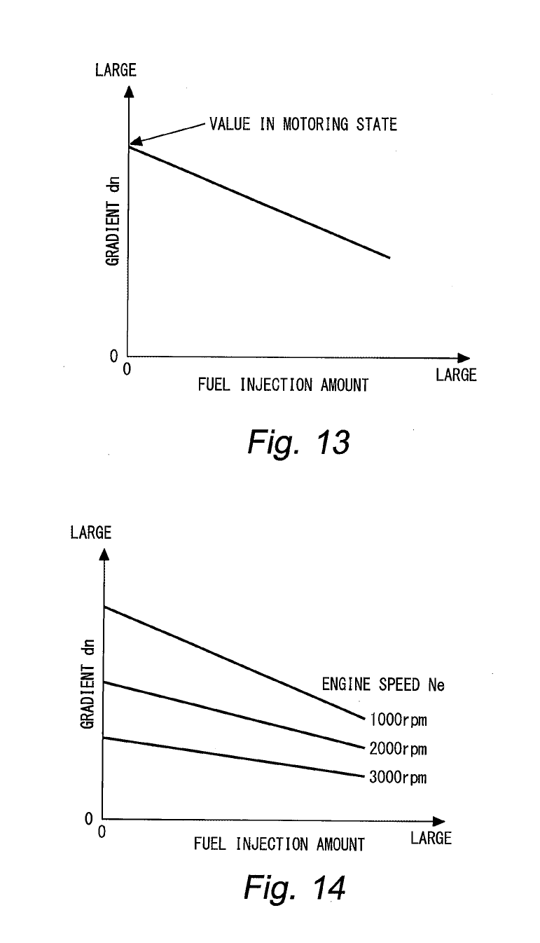

In the present embodiment, in order to take the characteristics by the fuel injection amount like this into consideration, correction that relates the gradient dₙ calculated in the motoring state to the fuel injection amount is performed in the gradient correction section 46e. FIG. 13 is a diagram explaining a method for relating the gradient dₙ to the fuel injection amount. The gradient dₙ which is calculated in the motoring state can be said as the correction coefficient η at the time of the value Q of the fuel injection amount being zero, and therefore, the value of the gradient dₙ is taken for an intercept of a vertical axis. When the fuel injection amount increases, the deviation Δhₙ becomes small, and therefore, both the value Q and the value of the gradient dₙ are related to each other so that as the value Q of the fuel injection amount becomes larger, the value of the gradient d₀ becomes smaller (refer to equation (10) as follows).

Gradient dₙ=constant a×value Q of fuel injection amount+gradient dₙ_{_}_{Q=0} (10)

Further, the correction coefficient setting section 46 of the present embodiment outputs data (Q, dₙ) of the gradient to the storage section 42 as the correction coefficient η. When the storage section 42 receives data of the value Q of the fuel injection amount from the operation state determination section 32, the storage section 42 outputs the data of the correction coefficient η corresponding to the data to the in-cylinder pressure correction section 44. The in-cylinder pressure correction section 44 performs correction of the value Pₙ of the actual in-cylinder pressure in the non-motoring state by using the data of the correction coefficient η and the hysteresis zero angle H₀ which are received from the storage section 42. The value Pₙ of the actual in-cylinder pressure in the non-motoring state is corrected by equation (7) described above.

According to the present embodiment described above, correction that relates the gradient dₙ calculated in the motoring state to the fuel injection amount is performed. Accordingly, precision of correction of the data of the actual in-cylinder pressure in the non-motoring state can be enhanced more.

Incidentally, in the above described second embodiment, the gradient dₙ calculated in the motoring state is related to the fuel injection amount. However, the gradient dₙ may be related to not only the fuel injection amount but also the engine speed in the motoring state. FIG. 14 is an example of a diagram illustrating the relationship illustrated in FIG. 13 at each engine speed in the motoring state. In the example illustrated in FIG. 14, an influence which the fuel injection amount gives to the gradient dₙ becomes smaller as the engine speed becomes higher.

In this case, the data (Q, Ne, dₙ) of the gradient is outputted to the storage section 42 as the correction coefficient η. Subsequently, when the storage section 42 receives the data of the value Q of the fuel injection amount and data of a value Ne of the engine speed, the storage section 42 outputs the data of the correction coefficient η corresponding to the data to the in-cylinder pressure correction section 44. The processing in the in-cylinder pressure correction section 44 which is performed hereinafter is the same as in the above described second embodiment.

From the above, when not only the fuel injection amount but also the engine speed in the motoring state influences the gradient dₙ, the engine speed is added to a basis of correction of the gradient dₙ, and thereby it becomes possible to enhance precision of correction of the data of the actual in-cylinder pressure in the non-motoring state more.

What is claimed is:

1. A control device for a diesel engine which is configured to control a diesel engine including a glow plug integrated type in-cylinder pressure sensor,
wherein the control device is configured to:
determine a crank angle at which a difference, which is obtained by subtracting a reference in-cylinder pressure at a crank angle at which an actual in-cylinder pressure is detected, from the actual in-cylinder pressure detected by the in-cylinder pressure sensor at each of predetermined crank angles in a cycle in which the diesel engine is in a motoring state, changes from negative to positive;
calculate a rate of change of a pressure difference between the actual in-cylinder pressure and the reference in-cylinder pressure in a predetermined crank angle region at a retardation side from the crank angle at which the difference changes from negative to positive; and
correct the actual in-cylinder pressure detected at each of the predetermined crank angles in the cycle in which the diesel engine is in the non-motoring state, based on a crank angle interval from the crank angle at which the actual in-cylinder pressure is detected to the crank angle at which the difference changes from negative to positive, and the rate of change.

2. The control device for a diesel engine according to claim 1,
wherein the crank angle at which the difference changes from negative to positive is a crank angle at a retardation side from a compression top dead center.

3. The control device for a diesel engine according to claim 1,
wherein the control device is further configured to correct the rate of change by relating the rate of change to an amount of fuel that is injected into a cylinder of the diesel engine, wherein the rate of change is corrected to a smaller value as the amount of fuel is larger.

4. The control device for a diesel engine according to claim 3,
wherein the control device is further configured to correct the rate of change by relating the rate of change to an engine speed in the motoring state.

5. The control device for a diesel engine according to claim 1,
wherein the control device is further configured to before calculating the difference:
correct data of the actual in-cylinder pressure so that a maximum value of the actual in-cylinder pressure detected by the in-cylinder pressure sensor at each of the predetermined crank angles in the cycle in which the diesel engine is in the motoring state becomes equal to a maximum value of the reference in-cylinder pressure; and
correct the data of the actual in-cylinder pressure so that a crank angle showing the maximum value corresponds to a top dead center.

6. The control device for a diesel engine according to claim 1,
wherein the control device is further configured to correct the actual in-cylinder pressure detected at each of the predetermined crank angles in the cycle in which the diesel engine is in the non-motoring state, based on equation (1) as follows:
correction value of actual in-cylinder pressure=value Pₙ of actual in-cylinder pressure×(detection crank angle θₙ−hysteresis zero angle H₀)×correction coefficient η (1),
in equation (1), the value Pₙ of the actual in-cylinder pressure means the actual in-cylinder pressure detected at each of the predetermined crank angles in the cycle in which the diesel engine is in the non-motoring state, the detection crank angle θₙ means the crank angle at which the value Pₙ of the actual in-cylinder pressure is detected, the hysteresis zero angle H₀ means the crank angle at which the difference changes from negative to positive, and the correction coefficient η means the rate of change.

7. The control device for a diesel engine according to claim 1,
wherein the control device is further configured to correct the actual in-cylinder pressure detected at each of the predetermined crank angles in the cycle in which the diesel engine is in the non-motoring state, based on equation (2) as follows:
correction value Pₙ of actual in-cylinder pressure=value Pₙ of actual in-cylinder pressure×(detection crank angle θₙ−hysteresis zero angle H₀)×correction coefficient η/100 (2),
in equation (2), the value Pₙ of the actual in-cylinder pressure means the actual in-cylinder pressure detected at each of the predetermined crank angles in the cycle in which the diesel engine is in the non-motoring state, the detection crank angle θₙ means the crank angle at which the value Pₙ of the actual in-cylinder pressure is detected, the hysteresis zero angle H₀ means the crank angle at which the difference changes from negative to positive, and the correction coefficient η means a percentage of a value obtained by dividing the rate of change by the reference in-cylinder pressure.
